(19) United States
(12) Patent Application Publication
(10) Pub. No.: US 2026/0359480 A1
(43) Pub. Date: Nov. 12, 2026

(54) METHOD AND SYSTEM FOR SECURELY PROCESSING SENSITIVE DATA USING DUAL-ENVIRONMENT ARCHITECTURE

(71) Applicant: IMPERVA, Inc., San Mateo, CA (US)

(72) Inventors: Matan LION, Mahane Yaffe (IL); Aiah LERNER, Ramat Gan (IL); Eytan Shalom NAIM, Modiin (IL)

(73) Assignee: IMPERVA, INC., San Mateo, CA (US)

(21) Appl. No.: 19/200,810

(22) Filed: May 7, 2025

(51) Int. Cl. G06F 21/62

(52) U.S. Cl. CPC G06F 21/6254

(57) ABSTRACT

A method (500) and a system (100) for securely processing sensitive data (318) using a dual-environment architecture is disclosed. The method (500) comprises receiving (502) a user request comprising sensitive data (318) in an original form, anonymizing (504) the user request by replacing the sensitive data (318) with anonymized tokens, and transmitting (506) the anonymized user request from a secured environment (302) to an application within an untrusted environment (304). The method (500) further comprises transmitting (508) a response comprising action instructions (320) from the untrusted environment (304) to the secured environment (302). The method (500) further comprises de-anonymizing (510) the response by replacing the anonymized tokens corresponding to the sensitive data (318) with the sensitive data (318) in the original form and executing (512) the action instructions (320) on sensitive data sources (322) in the secured environment (302).

### TECHNICAL FIELD

The present technology relates to the field of data security and artificial intelligence (AI), specifically to systems and methods for securely processing sensitive data and accessing internal secured systems using Large Language Models (LLMs) instructions. More particularly, but not by way of limiting, the present technology relates to a dual-environment architecture that separates the processing of sensitive data from the LLM logic, ensuring that sensitive information remains within a secured environment while leveraging the capabilities of LLMs in an untrusted environment.

### BACKGROUND

In recent years, Large Language Models (LLMs) have demonstrated remarkable potential in extracting insights from complex datasets, offering intuitive natural language interfaces that benefit professionals across various industries. These AI-driven solutions are increasingly being adopted for tasks such as data analysis, process automation, and real-time decision support. However, the use of LLMs in enterprise environments often requires direct access to sensitive or regulated information, such as patient records, financial transactions, or legal documents. This raises significant concerns around data leakage, unauthorized access, and compliance violations.

Traditional approaches to addressing these concerns comprise fully on-premises LLM deployments and simple encryption and authentication measures. While on-premises deployments provide greater control over data, they demand significant hardware resources and ongoing model maintenance, making them costly and resource-intensive. On the other hand, cloud-based LLM services offer convenience, scalability, and access to the latest AI advancements but expose organizations to compliance risks if sensitive data is transmitted beyond protected boundaries.

Moreover, existing solutions often provide limited oversight over how external LLM services generate or execute queries against internal systems. This results in complex integrations that require high technical expertise and expose enterprises to unacceptable risks, slowing the adoption of AI-powered tools in mission-critical workflows. Standard security measures, such as encryption-in-transit, user authentication, or standalone policy enforcement, do not inherently address the need to filter and mask sensitive data before it enters the LLM workflow. They also fail to ensure that actions proposed by the model (e.g., database queries, file access) go through proper authorization in the enterprise environment.

The above context underscores the tension between the promise of LLM-driven innovations and the requirements of corporate security and compliance teams. There is a clear need for a framework that can isolate and protect sensitive data and internal secured systems without diluting the power of LLM-based analytics or overwhelming non-technical users with complicated query languages and security configurations. The present disclosure addresses these challenges by proposing a dual-environment architecture that decouples the processing of sensitive data from the core LLM logic, enabling advanced analytics, automation, and user-friendly interactions without sacrificing security or regulatory conformity.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure relates to a method and system for securely processing sensitive data using a dual-environment architecture. In one aspect of the present disclosure, the method comprises receiving, by a processor and in a secured environment, a user request comprising the sensitive data in an original form via a user interface. The method further comprises anonymizing, by the processor and in the secured environment, the user request by replacing the sensitive data with anonymized tokens, wherein a session-based mapping is maintained between the sensitive data and the anonymized tokens. The anonymized user request is transmitted from the secured environment to an application within an untrusted environment, where the application uses one or more Large Language Models (LLMs). The application generates a response comprising action instructions, which is transmitted back to the secured environment without direct access to the sensitive data. The response is de-anonymized by replacing the anonymized tokens with the original sensitive data using the session-based mapping. Also, the action instructions are executed on sensitive data sources within the secured environment.

In accordance with an embodiment, the one or more LLMs are pre-trained.

In accordance with an embodiment, the anonymizing step further comprises identifying the sensitive data in the user request using Personally Identifiable Information (PII) classification techniques and replacing the sensitive data with anonymized tokens while maintaining the session-based mapping between the sensitive data and the anonymized tokens.

In accordance with an embodiment, the action instructions comprise any actions in the secured environment (302) comprising at least one of database queries, report generation, log analysis, and/or document retrieval, and the action instructions are validated against a set of pre-defined rules to ensure that actions performed within the secured environment align with security policies.

In accordance with an embodiment, the method further comprises encrypting a connection between the secured environment and the untrusted environment using any method for secured application layer communication method comprising Secure Sockets Layer (SSL) encryption.

In accordance with an embodiment, the method further comprises authorizing the execution of the action instructions based on user-level permissions before executing the action instructions in the secured environment.

In accordance with an embodiment, the method further comprises enriching the one or more LLMs, in the untrusted environment, with non-sensitive metadata about the secured environment, comprising available actions, to generate the action instructions without direct access to the sensitive data.

In accordance with an embodiment, the method further comprises storing, in the secured environment, a history of anonymized user requests and responses to improve the relevance of future responses.

In accordance with an embodiment, the sensitive data sources comprise any internal system or database within the secured environment comprising at least one of a vector database, Active Directory, or a logs database.

In another aspect of the present disclosure, a system for securely processing sensitive data using a dual-environment architecture is disclosed. The system comprises a processor and a memory communicatively coupled to the processor. The memory stores processor-executable instructions, which, on execution, cause the processor to receive, in a secured environment, a user request comprising sensitive data in an original form via a user interface. Additionally, the processor is configured to anonymize, in the secured environment, the user request by replacing the sensitive data with anonymized tokens, wherein a session-based mapping is maintained between the sensitive data and the anonymized tokens. Further, the processor is configured to transmit the anonymized user request from the secured environment to an application within an untrusted environment, where the application uses one or more Large Language Models (LLMs). Further, the processor is configured to transmit a response comprising action instructions from the untrusted environment to the secured environment, without direct access to the sensitive data, in response to receiving the anonymized user request, where the response is generated using the application. Furthermore, the processor is configured to de-anonymize the response by replacing the anonymized tokens corresponding to the sensitive data with the sensitive data in the original form using the session-based mapping. Also, the processor is configured to execute, in the secured environment, the action instructions on sensitive data sources.

In accordance with an embodiment, the one or more LLMs are pre-trained. The LLMs are enriched with non-sensitive metadata about the secured environment, comprising available actions, to generate action instructions without direct access to the sensitive data.

In accordance with an embodiment, the system stores a history of anonymized user requests and responses in the secured environment to improve the relevance of future responses, and the processor-executable instructions further cause the processor to identify the sensitive data in the user request using PII classification techniques and replace the sensitive data with anonymized tokens while maintaining the session-based mapping.

In accordance with an embodiment, the action instructions comprise at least one of database queries, report generation, log analysis, and/or document retrieval, and the execution of the action instructions is authorized based on user-level permissions before executing the action instructions in the secured environment. The sensitive data sources any action on internal and sensitive systems in the secured environment, comprising at least one of a vector database, Active Directory, or a logs database.

In accordance with an embodiment, the connection between the secured environment and the untrusted environment is encrypted using any method for secured application layer communication method comprising Secure Sockets Layer (SSL) encryption.

In yet another aspect of the present disclosure, a non-transitory computer-readable medium storing computer-executable instructions for securely processing sensitive data using a dual-environment architecture is disclosed. The computer-executable instructions are configured for receiving, in a secured environment, a user request comprising the sensitive data in an original form via a user interface. Additionally, the computer-executable instructions are configured for anonymizing, in the secured environment, the user request by replacing the sensitive data with anonymized tokens, where a session-based mapping is maintained between the sensitive data and the anonymized tokens. Further, the computer-executable instructions are configured for transmitting the anonymized user request from the secured environment to an application within an untrusted environment, where the application uses one or more Large Language Models (LLMs). Further, the computer-executable instructions are configured for transmitting a response comprising action instructions from the untrusted environment to the secured environment, without direct access to the sensitive data, in response to receiving the anonymized user request, where the response is generated using the application. Furthermore, the computer-executable instructions are configured for de-anonymizing the response by replacing the anonymized tokens corresponding to the sensitive data with the sensitive data in the original form using the session-based mapping. Also, the computer-executable instructions are configured for executing, in the secured environment, the action instructions on sensitive data sources

It is to be understood that both the foregoing general description and the following detailed description are exemplary and explanatory only and are not restrictive of the disclosure, as claimed.

### BRIEF DESCRIPTION OF THE DRAWINGS

The above-mentioned implementations are further described herein with reference to the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalent thereof.

FIG. 1 is a diagram illustrating various exemplary components of a system for securely processing sensitive data using a dual-environment architecture, in accordance with an embodiment of the present disclosure.

FIG. 2 is a diagram illustrating an exemplary environment for various modules within a processor, in accordance with an embodiment of the present disclosure.

FIG. 3 is a diagram illustrating an exemplary environment for securely processing sensitive data using a dual-environment architecture, in accordance with an embodiment of the present disclosure.

FIG. 4 is a diagram illustrating another exemplary environment for securely processing sensitive data using a dual-environment architecture, in accordance with an embodiment of the present disclosure.

FIG. 5 illustrates an exemplary flow chart depicting a method for securely processing sensitive data using a dual-environment architecture, in accordance with an embodiment of the present disclosure.

FIG. 6 illustrates an exemplary environment suitable for implementing various embodiments of the present disclosure.

### DETAILED DESCRIPTION

In the following descriptions, certain specific details are set forth in order to provide a thorough understanding of various disclosed embodiments. However, one skilled in the relevant art will recognize that embodiments maybe practiced without one or more of the specific details, or with other methods, components, materials, etc. In other instances, well-known structures of methods associated with the modular seating unit system have not been shown or described in detail to avoid unnecessarily obscuring descriptions of the embodiments.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

In the specification, the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

In the specification, the term “engage” and its variants comprising “engagement,” “engages,” “engaging,” and “engaged” as used herein are to be interpreted to comprise engagement by touching, rubbing, or abutting, comprising engagement in one or more of an axial, radial, tangential, and circumferential direction, and comprises engagement through an intermediary such as a component positioned or sandwiched between the counter face and head of the fastener.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the disclosure may be readily combined, without departing from the scope or spirit of the disclosure.

Certain terminology used in the description is for convenience in reference only and shall not be limiting. For example, terms such as “secured environment,” “untrusted environment,” “sensitive data,” and “anonymized tokens” refer to the disclosed subject matter as described in the context of the disclosure. The words “inwardly,” “outwardly,” “forward,” and “backward” refer to directions toward and away from, respectively, the geometric center of the aspect being described and designated parts thereof. The terminology will comprise the words specifically mentioned, derivatives thereof, and words of similar meaning. Like reference numbers denote like features, components, or elements throughout the various embodiments.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” comprises plural references. The meaning of “in” comprises “in” and “on.”

Features that are described in the context of an embodiment may correspondingly be applicable to the same or similar features in other embodiments. Features that are described in the context of an embodiment may correspondingly be applicable to other embodiments, even if not explicitly described in these other embodiments. Furthermore, additions and/or combinations and/or alternatives as described for a feature in the context of an embodiment may correspondingly be applicable to the same or similar feature in other embodiments.

To achieve the stated features, advantages, and objects, the present disclosure is directed to a method and system for securely processing sensitive data and accessing internal systems in secured environments using a dual-environment architecture. The disclosure is designed to address the challenges associated with leveraging Large Language Models (LLMs) in enterprise environments, where the sensitive data must be protected from unauthorized access, data leakage, and compliance violations. The disclosure provides a secure framework that allows organizations to utilize advanced AI-driven analytics and automation without compromising data security or regulatory compliance.

Throughout the specification, the term “Secured Environment” may refer to a controlled and protected computing environment, fully managed by the organization, where the sensitive data is processed, stored, and executed. This environment ensures that the sensitive data remains within the organization's boundaries and is not exposed to external systems or unauthorized entities.

Throughout the specification, the term “Untrusted Environment” may refer to an external or cloud-based computing environment where Large Language Models (LLMs) operate. This environment is considered untrusted because it may be managed by third-party providers, and the sensitive data is not directly accessible or stored within it. The untrusted environment processes anonymized requests and generates responses without direct access to sensitive data.

Throughout the specification, the term “Sensitive Data” may refer to any information that requires protection due to its confidential, proprietary, or regulated nature. Examples comprise personally identifiable information (PII), financial records, healthcare data, legal documents, and other types of data that are subject to privacy laws, compliance regulations, or organizational security policies.

Throughout the specification, the term “Anonymized Tokens” may refer to random or pseudorandom identifiers that replace the sensitive data in user requests before the user requests are transmitted to the untrusted environment. These tokens maintain a session-based mapping to the original sensitive data, allowing the system to de-anonymize responses in the secured environment without exposing sensitive information to the untrusted environment.

Throughout the specification, the term “Large Language Models (LLMs)” may refer to advanced artificial intelligence models trained on large datasets to understand, generate, and process natural language. These models are capable of performing tasks such as data analysis, report generation, log analysis, and document retrieval. In the context of this disclosure, LLMs operate in the untrusted environment and generate responses based on anonymized requests.

Throughout the specification, the term “Action Instructions” may refer to commands or operations generated by the LLMs in response to user requests. These instructions may comprise database queries, report generation, log analysis, document retrieval, or other tasks that comprise interacting with sensitive data sources. Action instructions are executed in the secured environment after being de-anonymized and authorized.

Throughout the specification, the term “Session-Based Mapping” may refer to a temporary and secure mapping maintained in the secured environment between the sensitive data and anonymized tokens. This mapping ensures that sensitive data can be accurately de-anonymized after processing in the untrusted environment, without exposing the original data to external systems.

Throughout the specification, the term “Secure Sockets Layer (SSL) Encryption” may refer to a cryptographic protocol used to encrypt the connection between the secured environment and the untrusted environment. SSL ensures that data transmitted between these environments is protected from interception or tampering, maintaining the integrity and confidentiality of the communication.

Throughout the specification, the term “User-Level Permissions” may refer to access controls that determine which actions a user is authorized to perform within the secured environment. These permissions ensure that only authorized users can execute action instructions on sensitive data sources, further enhancing the security of the system.

Throughout the specification, the term “Sensitive Data Sources” may refer to databases, directories, or other storage systems that comprise sensitive information. Examples comprise vector databases, Active Directory, and logs databases, which store structured or unstructured data that must be protected from unauthorized access.

Based on the context, ‘sensitive data’ and ‘embedded sensitive data’ may be used interchangeably for better understanding and clarity.

The disclosed system addresses the technical problem of securely processing the sensitive data in enterprise environments while leveraging the capabilities of Large Language Models (LLMs). Conventional solutions, such as fully on-premises LLM deployments or simple encryption and authentication measures, struggle to balance robust AI functionality with stringent security and privacy controls. On-premises deployments require significant hardware resources and ongoing maintenance, while cloud-based LLM services expose organizations to compliance risks if the sensitive data is transmitted beyond protected boundaries. Additionally, traditional approaches often lack oversight over how external LLM services generate or execute queries against internal systems, leading to complex integrations, high technical expertise requirements, and increased risk of data leakage or unauthorized access.

The disclosure achieves its objectives by introducing a dual-environment architecture that separates the processing of sensitive data from the LLM logic. The system operates in two distinct environments: a secured environment, fully controlled by the organization, where the sensitive data is processed and stored, and an untrusted environment, where LLMs generate responses based on anonymized requests. The sensitive data is anonymized before being transmitted to the untrusted environment, ensuring that the LLMs never have direct access to the original data. The system maintains a session-based mapping between the original sensitive data and anonymized tokens, allowing for accurate de-anonymization of responses in the secured environment. This approach enables organizations to leverage state-of-the-art LLMs for advanced analytics, automation, and user-friendly interactions without compromising data security or regulatory compliance.

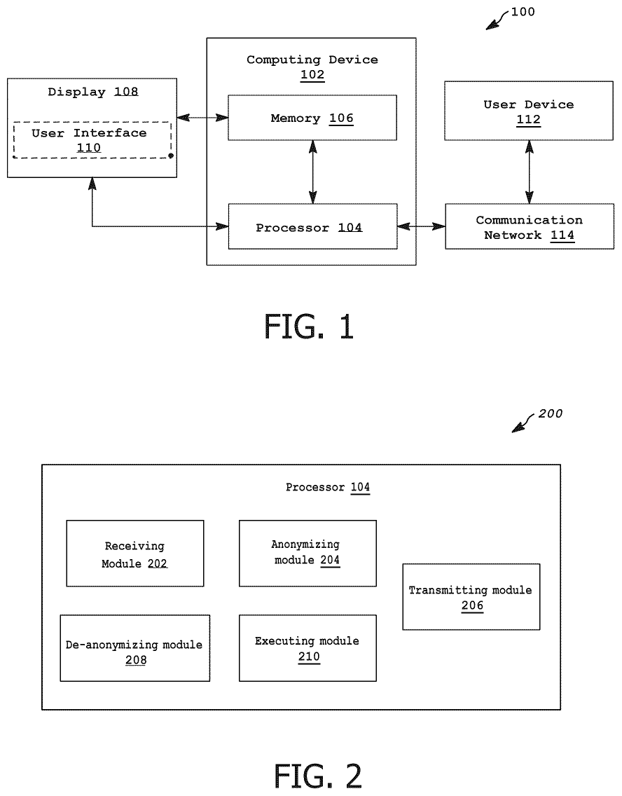

Embodiments of the present disclosure provide a method and system for securely processing the sensitive data using a dual-environment architecture. The method and system are designed to ensure that the sensitive data remains protected while allowing organizations to utilize the full potential of LLMs for tasks such as data analysis, report generation, log analysis, and document retrieval. The system comprises components for user request anonymization, LLM response generation, response de-anonymization, and action execution within the secured environment. The connection between the secured and untrusted environments is encrypted using any secured communication protocol, comprising, but not limited to, Secure Sockets Layer (SSL), and user-level permissions ensure that only authorized actions are executed on sensitive data sources. The disclosure is described in detail with reference to FIG. 1 to FIG. 6 as provided in the accompanying drawings.

FIG. 1 is a diagram illustrating various exemplary components of a system 100 for securely processing sensitive data using a dual-environment architecture, in accordance with an embodiment of the present disclosure. With reference to FIG. 1, the system 100 comprises a computing device 102, a processor 104, a memory 106, a display 108, a user interface 110, a user device 112, and a communication network 114. These components work together to enable secure processing of the sensitive data while leveraging the capabilities of Large Language Models (LLMs) in an untrusted environment.

The communication network 114 serves as the medium facilitating data transfer between the computing device 102 and the user device 112. The communication network 114 may be wired, wireless, or any combination of wired and wireless communication networks, such as cellular networks, Wi-Fi, the internet, local area networks (LANs), or the like. In one embodiment, the communication network 114 may comprise one or more networks such as a data network, a wireless network, a telephony network, or any combination thereof. The data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies comprising enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The user device 112 may comprise a range of devices, such as a smartphone, tablet, desktop computer, or laptop. These devices represent various types of user equipment that can access and interact with the computing device 102 via the communication network 114. Each device may be configured to send and receive data across the network in a manner that ensures secure and reliable interaction with the system 100. A person of ordinary skill in the art will appreciate that the user device 112 may comprise, but is not limited to, intelligent, multi-sensing, network-connected devices, that may integrate seamlessly with each other and/or with a central server or a cloud-computing system or any other device that is network-connected.

Additionally, in some embodiments, the user device 112 may comprise, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user device 112 may comprise, but is not limited to, any electrical, electronic, electromechanical, or equipment, or a combination of one or more of the above devices, such as virtual reality (VR) devices, augmented reality (AR) devices, laptop, a general-purpose computer, desktop, personal digital assistant, tablet computer, mainframe computer, or any other computing device. The user device 112 may comprise one or more in-built or externally coupled accessories comprising, but not limited to, a visual aid device such as a camera, an audio aid, a microphone, a keyboard, and input devices for receiving input from the user or the entity such as a touchpad, touch-enabled screen, electronic pen, and the like. A person of ordinary skill in the art will appreciate that the user device 112 may not be restricted to the mentioned devices and various other devices may be used.

The computing device 102 is communicatively coupled to the processor 104 and the memory 106, which together form the core processing unit of the system 100. The processor 104 is responsible for executing instructions stored in the memory 106, which comprise modules for receiving, anonymizing, transmitting, de-anonymizing, and executing user requests and responses. The memory 106 stores processor-executable instructions, which, when executed by the processor 104, enable the system 100 to securely process the sensitive data using the dual-environment architecture. The display 108 and the user interface 110 serve as the primary means of interaction between the user and the system 100. The user interface 110 captures user inputs, such as requests comprising the sensitive data, and presents outputs, such as responses generated by the LLMs, to the user via the display 108.

The communication network 114 enables real-time communication between the user device 112 and the computing device 102, supporting a range of activities and data transactions. In some embodiments, the communication network 114 may represent various network types, comprising, but not limited to, wireless networks, the internet, cellular networks, or local area networks, providing flexible and dynamic connectivity for user devices. The communication network 114 ensures that data transmitted between the user device 112 and the computing device 102 is secure, encrypted, and compliant with organizational security policies.

In embodiments, the inclusion of the user device 112 offers users the flexibility to access and control the system 100 through diverse devices. This flexibility allows users to interact with the system 100 through a range of device interfaces, facilitating accessibility and convenience. The system 100, through the user interface 110 and the display 108, may provide feedback and data to the user device 112, enabling a responsive and user-centric interaction model. The user interface 110 is designed to be intuitive and user-friendly, allowing non-technical users to leverage the capabilities of LLMs without requiring extensive technical expertise.

In embodiments, the system 100 enhances user accessibility to advanced AI-driven functionalities and secure data management capabilities via a centralized communication structure, which securely channels data to and from various types of the user device 112 through the communication network 114. The seamless integration of these components allows the system 100 to support a range of operational scenarios for users, improving access and control over system functionalities while ensuring the protection of the sensitive data. The system 100 is designed to operate in both secured and untrusted environments, ensuring that the sensitive data is processed securely while leveraging the power of LLMs for advanced analytics and automation.

FIG. 2 is a diagram illustrating an exemplary environment 200 for various modules within a processor, in accordance with an embodiment of the present disclosure. FIG. 2 is explained in conjunction with elements of FIG. 1. The environment 200 comprises the processor 104, which is configured to execute various modules for securely handling sensitive data. The modules comprise a receiving module 202, an anonymizing module 204, a transmitting module 206, a de-anonymizing module 208, and an executing module 210. Each module performs specific functions to ensure that the sensitive data is processed securely while leveraging the capabilities of Large Language Models (LLMs) in an untrusted environment.

In embodiments, the processor 104 is communicatively coupled to the receiving module 202, which serves as an entry point for user requests comprising the sensitive data. The receiving module 202 is configured to receive the user requests via the user interface 110 (as shown in FIG. 1). The user requests may comprise the sensitive data such as, but is not limited to, personally identifiable information (PII), financial records, or healthcare data. The receiving module 202 ensures that the user requests are securely captured and passed to the next module for further processing.

The anonymizing module 204 is communicatively coupled to the receiving module 202. The anonymizing module 204 may be responsible for identifying the sensitive data within the user request and replacing the sensitive data with anonymized tokens. The anonymizing module 204 uses Personally Identifiable Information (PII) classification techniques to detect the sensitive data. Additionally, the anonymizing module 204 maintains a session-based mapping between the original sensitive data and the anonymized tokens. The mapping may ensure that the sensitive data can be accurately restored during the de-anonymization process.

In embodiments, the transmitting module 206 is communicatively coupled to the anonymizing module 204. The transmitting module 206 is configured to transmit the anonymized user request from the secured environment to an untrusted environment. In the untrusted environment, the anonymized request is processed by one or more Large Language Models (LLMs). The transmitting module 206 ensures that the connection between the secured environment and the untrusted environment is encrypted using Secure Sockets Layer (SSL) encryption. The above-mentioned encryption may prevent unauthorized access to the sensitive data during transmission.

In embodiments, the de-anonymizing module 208 is communicatively coupled to the transmitting module 206. The de-anonymizing module 208 may be responsible for receiving the response generated by the LLMs in the untrusted environment. The response may comprise action instructions such as database queries, report generation, or document retrieval. The de-anonymizing module 208 replaces the anonymized tokens in the response with the original sensitive data using the session-based mapping. The replacement ensures that the response is accurately restored to its original form before being processed further.

In embodiments, the executing module 210 is communicatively coupled to the de-anonymizing module 208. The executing module 210 is configured to execute the action instructions on sensitive data sources within the secured environment. The sensitive data sources may comprise, but is not limited to, a vector database, Active Directory, or a logs database. The executing module 210 ensures that the action instructions are authorized based on user-level permissions before execution. The above-mentioned authorization step prevents unauthorized access to the sensitive data.

In an exemplary operation, the receiving module 202 may capture a user request comprising the sensitive data via the user interface 110. The anonymizing module 204 identifies the sensitive data and replaces the sensitive with anonymized tokens. The transmitting module 206 may send the anonymized request to the untrusted environment, where the one or more LLMs generate a response. The de-anonymizing module 208 restores the original sensitive data in the response. Finally, the executing module 210 executes the action instructions on the sensitive data sources within the secured environment.

The environment 200 supports real-time processing of the sensitive data while maintaining strict security controls. The anonymizing module 204 and the de-anonymizing module 208 ensure that the sensitive data is never exposed to the untrusted environment. The transmitting module 206 ensures secure communication between the secured and untrusted environments. The executing module 210 ensures that only authorized actions are performed on sensitive data sources.

The environment 200 also supports stateless communication, meaning that each user request is processed independently without retaining any session data in the untrusted environment. This approach minimizes the risk of data leakage and ensures that the sensitive data is processed securely. The session-based mapping maintained by the anonymizing module 204 and the de-anonymizing module 208 ensures that the sensitive data is accurately restored after processing.

By implementing the environment 200, organizations can leverage the capabilities of Large Language Models (LLMs) for advanced analytics and automation without compromising data security. The environment 200 provides a scalable and secure framework for processing the sensitive data in compliance with regulatory requirements. The modular design of the environment 200 allows for easy integration with existing systems and ensures that the sensitive data is protected at all stages of processing.

The environment 200 illustrates an efficient framework for securely processing the sensitive data using a dual-environment architecture. Through the coordinated interaction of the receiving module 202, the anonymizing module 204, the transmitting module 206, the de-anonymizing module 208, and the executing module 210, the environment 200 ensures that the sensitive data is processed securely while leveraging the power of LLMs for advanced analytics and automation. This setup provides a scalable, secure approach to data processing, supporting both individual and bulk operations across multiple user requests.

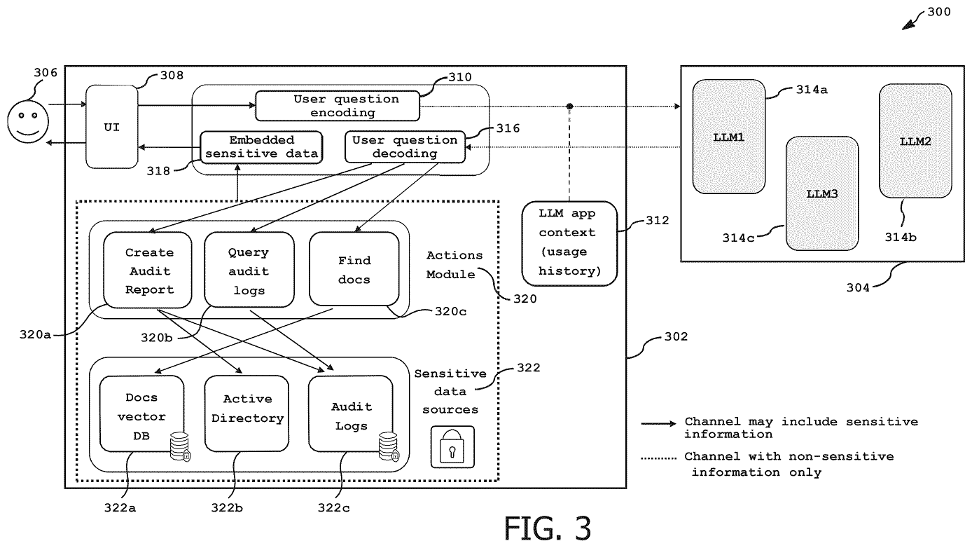

FIG. 3 is a diagram illustrating an exemplary environment 300 for securely processing sensitive data using a dual-environment architecture, in accordance with an embodiment of the present disclosure. FIG. 3 may be explained in conjunction with elements of FIG. 1 and FIG. 2. The environment 300 may comprise a secured environment 302, an untrusted environment 304, and a user 306. The secured environment 302 and the untrusted environment 304 may be designed to operate independently, ensuring that the sensitive data 318 may be processed securely while leveraging the capabilities of Large Language Models (LLMs) in the untrusted environment 304.

In embodiments, the secured environment 302 may be fully managed and controlled by the organization. The secured environment 302 may be responsible for handling all operations comprising the sensitive data 318, ensuring that the sensitive data 318 may remain within the organization's protected boundaries. Additionally, the secured environment 302 may comprise several components such as, a user interface (UI) 308, a user request anonymization module (e.g., user question encoding 310), an LLM application (app) context module 312, a user response de-anonymization module (e.g., user question decoding 316), an actions module 320, and sensitive data sources 322. The above-mentioned components may work together to ensure that the sensitive data (e.g., embedded sensitive data 318) may be processed securely and that only authorized actions may be performed.

The user interface (UI) 308 may serve as the primary point of interaction between the user 306 and the system 100. The UI 308 may allow the user 306 to submit requests comprising the sensitive data 318, such as, but not limited to, queries for generating reports, analyzing logs, or retrieving documents. The UI 308 may capture the user's input and pass the user's input to the user request anonymization module 310 for further processing.

The user request anonymization module 310 may be responsible for identifying the sensitive data 318 within the user's request and replacing the sensitive data 318 with anonymized tokens. The user request anonymization module 310 may use Personally Identifiable Information (PII) classification techniques to detect the sensitive data 318, such as, but not limited to, names, addresses, or financial information. The anonymization process may ensure that the sensitive data 318 may not be exposed to the untrusted environment 304. The user request anonymization module 310 may maintain a session-based mapping between the original sensitive data 318 and the anonymized tokens, which may be used later to restore the original data during the de-anonymization process.

The LLM app context module 312 may store non-sensitive contextual information related to the user's interactions with the system 100. The LLM app context module 312 may maintain a history of anonymized user requests and responses, which may be used to improve the relevance of future responses. The LLM app context module 312 may ensure that no sensitive data 318 may be stored in the untrusted environment 304, further enhancing data security.

The untrusted environment 304 may comprise the one or more Large Language Models (LLMs) 314, which may be responsible for processing anonymized user requests and generating responses. The one or more LLMs 314 may comprise multiple models, such as FIRST LLM 314a, SECOND LLM 314b, and THIRD LLM 314c, each specialized for different tasks, such as generating free-text responses, creating database queries, or validating queries. The untrusted environment 304 may not have direct access to the sensitive data 318 or internal enterprise systems, ensuring that sensitive information may remain protected.

The user response de-anonymization module 316 may be responsible for restoring the original sensitive data 318 in the response generated by the one or more LLMs 314. The user response de-anonymization module 316 may use the session-based mapping created during the anonymization process to replace the anonymized tokens with the original sensitive data. The replacement may ensure that the response presented to the user 306 may comprise the correct information without exposing the sensitive data 318 to the untrusted environment 304.

The actions module 320 may represent a suite of system-available functions that the one or more LLMs 314 may instruct to perform via the action instructions generated by the one or more LLMs 314. The system-available functions may comprise creating reports 320a, analyzing logs 320b, or finding documents 320c. The actions module 320 may interact with internal databases (sensitive data sources 322), such as, but not limited to, a documents vector database 322a, Active Directory 322b, or a logs database 322c, to fulfill the LLM's instructions. Additionally, actions module 320 may interact with internal systems internal systems that may not be accessed remotely and therefore, action instructions may be provided from the external non trusted environment. All actions may be performed within the secured environment 302 and may be authorized based on user-level permissions, ensuring that only authorized users may execute sensitive operations.

The sensitive data sources 322 may comprise various databases and directories that may store sensitive information. The sensitive data sources 322 may be accessed by the actions module 320 to retrieve or update data as instructed by the one or more LLMs 314. The sensitive data sources 322 may be protected within the secured environment 302, ensuring that the sensitive data 318 may not be exposed to external systems or unauthorized entities.

In an exemplary operation, the user 306 may interact with the UI 308 to submit a request comprising the sensitive data 318. The user request anonymization module 310 may identify the sensitive data 318 and replace the sensitive with anonymized tokens. The anonymized request may then be transmitted to the untrusted environment 304, where the one or more LLMs 314 may process the request and generate a response. The response may comprise free text and action instructions, such as database queries or report generation.

The response may be sent back to the secured environment 302, where the user response de-anonymization module 316 may restore the original sensitive data using the session-based mapping. If the response may comprise action instructions, the actions module 320 may execute the instructions on the sensitive data sources 322, ensuring that all operations may be authorized and performed within the secured environment 302. The results of the actions may be embedded in the final response, which may be presented to the user 306 through the UI 308.

The environment 300 may support stateless communication, meaning that each user request may be processed independently without retaining any session data in the untrusted environment 304. This approach may minimize the risk of data leakage and may ensure that the sensitive data 318 may be processed securely. The session-based mapping maintained by the user request anonymization module 310 and the user response de-anonymization module 316 may ensure that the sensitive data 318 may be accurately restored after processing.

By implementing the environment 300, organizations may leverage the capabilities of Large Language Models (LLMs) for advanced analytics and automation without compromising data security. The environment 300 may provide a scalable and secure framework for processing the sensitive data 318 in compliance with regulatory requirements. The modular design of the environment 300 may allow for easy integration with existing systems and may ensure that the sensitive data 318 may be protected at all stages of processing.

The environment 300 may illustrate an efficient framework for securely processing the sensitive data 318 using a dual-environment architecture. Through the coordinated interaction of the secured environment 302 and the untrusted environment 304, the environment 300 may ensure that the sensitive data 318 may be processed securely while leveraging the power of LLMs for advanced analytics and automation. This setup may provide a scalable, secure approach to data processing, supporting both individual and bulk operations across multiple user requests.

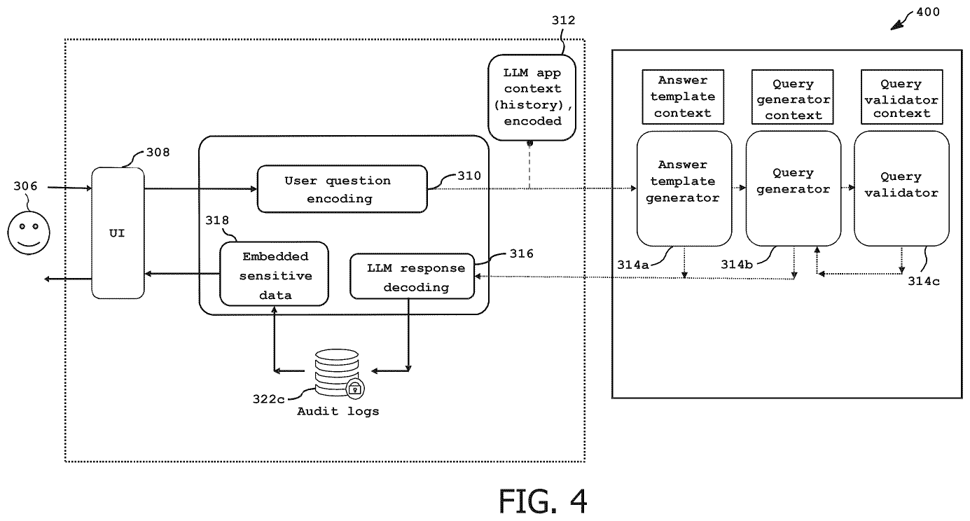

FIG. 4 is a diagram illustrating an exemplary environment 400 for securely processing sensitive data using a dual-environment architecture, in accordance with an embodiment of the present disclosure. FIG. 4 may be explained in conjunction with elements of FIG. 1, FIG. 2, and FIG. 3. The environment 400 may comprise the user 306, the user interface (UI) 308, the user request anonymization module 310, the LLM app context module 312, Large Language Models (LLMs) 314, the user response de-anonymization module 316, and the embedded the sensitive data 318. The environment 400 may showcase a specific implementation example of the system 100, where a chatbot may be designed to answer natural language user questions about File Access Monitoring (FAM) audit logs data.

In embodiments, the sensitive audit log data may be securely stored within the secured environment 302, while the chatbot's core logic may operate in the untrusted environment 304. The one or more LLMs 314 in the untrusted environment 304 may generate free-text answers to user queries, but importantly, the one or more LLMs 314 may also embed Action Instructions, such as database queries, within responses. The embedded instructions may be authorized and then executed in the secured environment 302 to fetch the relevant data that answers the user's question, maintaining a strict separation between the sensitive data 318 and processing of the one or more LLMs 314.

The user 306 may interact with the UI 308 to ask a question about the file access monitoring (FAM) audit logs. The user's question may be passed to the user request anonymization module 310, which may identify and replace the sensitive data 318 in the question with anonymized tokens. The anonymized request may then be sent to the untrusted environment 304, along with the LLM app context 312, which may comprise the user's conversation history to improve the relevance of the response.

The one or more LLMs 314 in the untrusted environment 304 may process the anonymized request. The one or more LLMs 314 may comprise first LLM 314a, which may act as an answer template generator, second LLM 314b, which may act as a query generator, and third LLM 314c, which may act as a query validator. The answer template generator (first LLM 314a) may generate the free text part of the response and may define Action Instructions to be forwarded to the query generator (second LLM 314b). The query generator (second LLM 314b) may generate MongoDB (database) queries based on the Action Instructions, and the query validator (third LLM 314c) may validate the queries to ensure the queries comply with predefined rules.

The response generated by the one or more LLMs 314 may be streamed back to the secured environment 302 in real-time. The user response de-anonymization module 316 may replace the anonymized tokens in the response with the original sensitive data using the session-based mapping. If the response comprises Action Instructions, such as database queries, these instructions may be executed on the sensitive data sources 322 within the secured environment 302. The results of the queries may be embedded in the final response, which may comprise the sensitive data 318.

The final response may be presented to the user 306 through the UI 308. The above-mentioned process may ensure that the sensitive data 318 may remain protected within the secured environment 302, while the one or more LLMs 314 in the untrusted environment 304 may generate accurate and relevant responses without direct access to sensitive information.

In an exemplary operation, the user 306 may ask a question about the FAM audit logs through the UI 308. The user request anonymization module 310 may anonymize the sensitive data in the question and send the anonymized request to the untrusted environment 304. The answer template generator (first LLM 314a) may generate a free-text response and define Action Instructions for the query generator (second LLM 314b). The query generator (second LLM 314b) may generate MongoDB queries, which may be validated by the query validator (third LLM 314c). The response may be sent back to the secured environment 302, where the user response de-anonymization module 316 may restore the original sensitive data. The Action Instructions may be executed on the sensitive data sources 322, and the final response may be presented to the user 306.

The environment 400 may illustrate an efficient framework for securely processing the sensitive data 318 using a dual-environment architecture. Through the coordinated interaction of the secured environment 302 and the untrusted environment 304, the environment 400 may ensure that the sensitive data 318 may be processed securely while leveraging the power of LLMs for advanced analytics and automation. This setup may provide a scalable, secure approach to data processing, supporting both individual and bulk operations across multiple user requests.

The LLM app component intermediate messages may further clarify how the LLM app works. The LLM output messages may be streamed back to the secured environment 302 in real-time as the LLM output messages are generated. These messages may be forwarded to the relevant LLMs 314 within the system either synchronously or streamed in parallel asynchronously. The answer template generator (first LLM 314a) may receive the user's question along with the user's context, comprising the conversation history. The system prompt may provide the first LLM 314a with metadata about the secured environment 302, such as awareness of the different Actions available in the system 100 and relevant LLMs. The response from first LLM 314a may comprise free text and an array with definitions of Action Instructions (tool calls). The query generator (second LLM 314b) may generate MongoDB queries based on the Action Instructions, and the query validator (third LLM 314c) may validate the queries to ensure the queries comply with predefined rules. The final response may be presented to the user 306 through the UI 308.

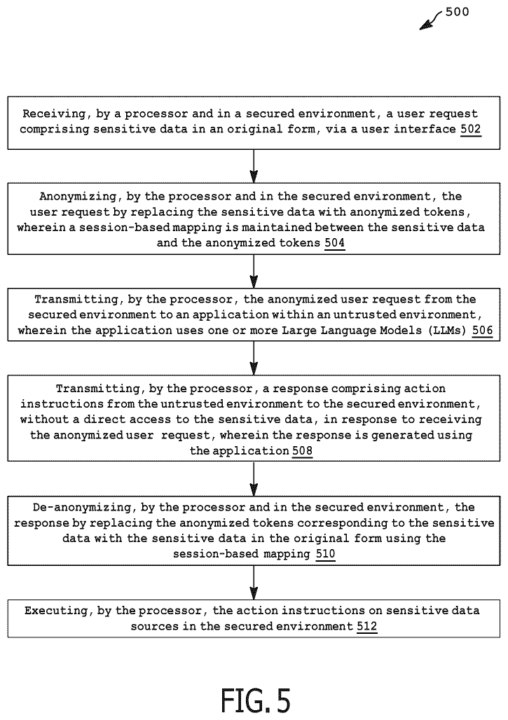

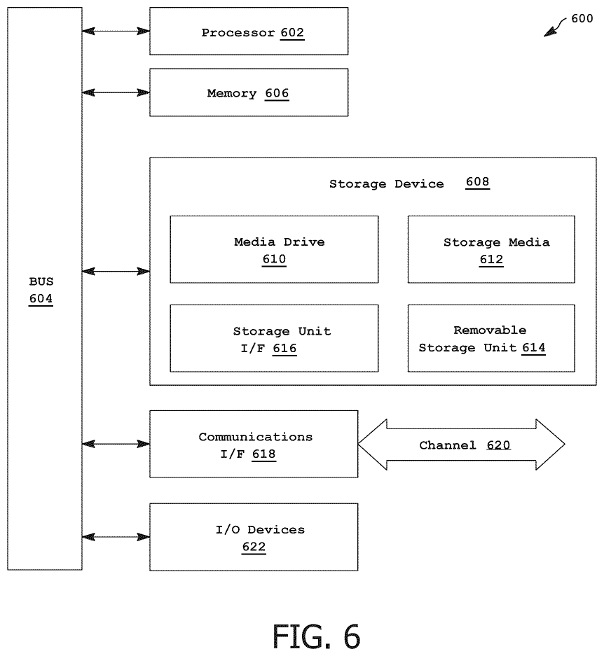

FIG. 5 illustrates an exemplary flow chart depicting a method 500 for securely processing sensitive data using a dual-environment architecture, in accordance with an embodiment of the present disclosure. It will be understood that each block of the flow diagram of the method 500 may be implemented by various means, such as hardware, firmware, processors, circuitry, and/or other communication devices associated with executing software, comprising one or more computer program instructions. For example, the procedures described in this method may be embodied by computer program instructions. In this regard, the computer program instructions that embody the procedures described above may be stored in a memory of a computing device, employing an embodiment of the present disclosure, and executed by a processor.

These computer program instructions may be stored in a computer-readable memory, which may direct a computer or other programmable apparatus to function in a specified manner. By doing so, the instructions stored in the computer-readable memory produce an article of manufacture, the execution of which implements the function specified in the flowchart blocks. The instructions may also be loaded onto a computer or programmable apparatus to initiate a series of operations on the device, resulting in a computer-implemented process in which the instructions executing on the apparatus provide operations that implement the functions specified in the flow diagram blocks.

Accordingly, the blocks of the flow diagram support combinations of means for performing the specified functions and combinations of operations for performing these functions. It will also be understood that one or more blocks of the flow diagram, and combinations of blocks within it, may be implemented by special-purpose hardware-based computer systems or a combination of special-purpose hardware and computer instructions.

FIG. 5 is explained in conjunction with elements from FIGS. 1, 2, 3, and 4. At step 502, the method 500 is initiated. The method 500, at step 502, may comprise receiving 502, by a processor 104 and in a secured environment 302, the user request comprising sensitive data in an original form, via the user interface 110. The user request may comprise the sensitive data such as personally identifiable information (PII), financial records, or healthcare data. The user interface 110 may serve as the primary point of interaction between the user 306 and the system 100, allowing the user to submit requests for tasks such as generating reports, analyzing logs, or retrieving documents.

At step 504, the method 500 may comprise anonymizing 504, by the processor (104) and in the secured environment 302, the user request by replacing the sensitive data 318 with anonymized tokens. A session-based mapping is maintained between the sensitive data 318 and the anonymized tokens. The anonymization process may use Personally Identifiable Information (PII) classification techniques to detect the sensitive data 318 in the user request. The sensitive data 318 may be replaced with anonymized tokens, and a session-based mapping may be created to link the original sensitive data with the anonymized tokens. This mapping may be used later to restore the original data during the de-anonymization process.

At step 506, the method 500 may comprise transmitting 506, by the processor 104, the anonymized user request from the secured environment 302 to an application within an untrusted environment 304. The application uses one or more Large Language Models (LLMs) 314. The untrusted environment 304 may comprise the one or more LLMs 314, which may process the anonymized request and generate a response. The connection between the secured environment 302 and the untrusted environment 304 may be encrypted using any secured cross applications communication protocol comprising, but not limited to, Secure Sockets Layer (SSL) encryption, ensuring that the data transmitted between the environments is protected from interception or tampering.

At step 508, the method 500 may comprise transmitting 508, by the processor 104, a response comprising action instructions 320 from the untrusted environment 304 to the secured environment 302, without a direct access to the sensitive data 318, in response to receiving the anonymized user request. The response is generated using the application. The response generated by the one or more LLMs 314 may comprise free text and action instructions 320, such as database queries, report generation, or document retrieval. The response may be transmitted back to the secured environment 302 for further processing.

At step 510, the method 500 may comprise de-anonymizing 510, by the processor 104 and in the secured environment 302, the response by replacing the anonymized tokens corresponding to the sensitive data 318 with the sensitive data 318 in the original form using the session-based mapping. The de-anonymization process may use the session-based mapping created during the anonymization process to restore the original sensitive data in the response. This ensures that the response presented to the user 306 comprises the correct information without exposing the sensitive data 318 to the untrusted environment 304.

At step 512, the method 500 may comprise executing 512, by the processor 104, the action instructions 320 on sensitive data sources 32 in the secured environment 302. The action instructions 320 may comprise tasks or actions in the secured environment 302 comprising, but not limited to creating reports, analyzing logs, or retrieving documents. These actions may be performed on the sensitive data sources 322, such as a documents vector database 322a, Active Directory 322b, or a logs database 322c, within the secured environment 302. The execution of the actions may be authorized based on user-level permissions, ensuring that only authorized users can perform sensitive operations.

The method 500 may conclude after step 512, ensuring that the user's (306) request has been processed securely and that the sensitive data has been protected throughout the entire process. The method 500 may provide a scalable and secure framework for processing the sensitive data 318 in compliance with regulatory requirements, allowing organizations to leverage the capabilities of one or more Large Language Models (LLMs) 314 for advanced analytics and automation without compromising data security.

For the sake of explanation, consider an exemplary scenario where a user in a financial institution submits a request to generate a report comprising sensitive financial data. The user's request may be received by the user interface in the secured environment. The anonymizing module may identify the sensitive data 318 in the request, such as account numbers or transaction details, and replace it with anonymized tokens. The anonymized request may then be transmitted to the untrusted environment, where the LLMs may generate a response comprising free text and action instructions, such as a database query to retrieve the relevant financial data.

The response may be sent back to the secured environment, where the de-anonymizing module may restore the original sensitive data using the session-based mapping. The action instructions may be executed on the sensitive data sources, such as a financial database, within the secured environment. The results of the actions may be embedded in the final response, which may be presented to the user through the user interface.

By implementing the method 500, organizations may ensure that the sensitive data 318 is processed securely while leveraging the power of Large Language Models (LLMs) for advanced analytics and automation. The method 500 may provide a scalable, secure approach to data processing, supporting both individual and bulk operations across multiple user requests. This setup may enhance data security, ensure compliance with regulatory requirements, and enable organizations to fully utilize the capabilities of AI-driven tools without compromising sensitive information.

FIG. 6 illustrates an exemplary environment 600 suitable for implementing various embodiments of the present disclosure. The environment 600 comprises a processor 602, a bus 604, a memory 606, storage devices 608, a media drive 610, storage media 612, a removable storage unit 614, a storage unit interface (I/F) 616, a communication interface (I/F) 618, a communication channel 620, and input/output (I/O) devices 622.

The processor 602 serves as the central processing unit (CPU) within the environment 600, enabling control over the execution of instructions for performing operations in accordance with the present disclosure. The processor 602 is communicatively coupled with the memory 606 and storage devices 608 via the bus 604, which facilitates data transfer and synchronization across these components. In this manner, the processor 602 accesses data stored in the memory 606, retrieves instructions, and directs communication among various elements of the environment 600. The environment 600 may comprise one or more processors, such as processor 602, implemented using a general-purpose or specialized processing engine, such as a microprocessor, microcontroller, or other control logic. In some embodiments, processor 602 may be an AI processor, implemented as a Tensor Processing Unit (TPU), graphical processing unit (GPU), or custom-programmable solution, such as a Field-Programmable Gate Array (FPGA).

The bus 604 enables an efficient data flow pathway that connects the processor 602 to the memory 606 and storage devices 608, as well as to the communication interface 618 and the I/O devices 622. The bus 604 operates as a high-speed data communication link, allowing for real-time data transfer and ensuring coordination between system components for executing complex computational tasks and data management.

The memory 606 serves as a primary, volatile storage medium, storing data and instructions currently accessed and used by the processor 602. This memory may comprise dynamic random-access memory (DRAM), static random-access memory (SRAM), and/or other high-speed memory types, enabling rapid access to instructions and data required by the processor 602 for executing the functionalities of the environment 600.

The storage devices 608 provide non-volatile, persistent data storage and comprise various sub-components such as the media drive 610, storage media 612, removable storage unit 614, and storage unit interface 616. The media drive 610 facilitates reading and writing of data on storage media 612, which may comprise hard drives, solid-state drives, optical discs, and other types of physical storage media. These components collectively store long-term data and software applications, supporting the computing environment's ability to retain information across sessions and shutdowns.

The removable storage unit 614 provides an option for inserting and removing portable storage media, allowing external data transfer and backup. This component is accessible via the storage unit I/F 616, which serves as an interface for managing data transfer between the processor 602 and removable storage media, enabling the environment 600 to expand storage capacity and facilitate data interchange with external devices or systems.

The communication I/F 618 provides a pathway for the environment 600 to interact with external networks and devices. This interface enables data exchange and connectivity, supporting protocols such as Ethernet, Wi-Fi, cellular networks, and other wired or wireless communication protocols. The communication I/F 618 operates through the channel 620, which facilitates external data exchange, allowing the environment 600 to interact seamlessly with remote servers, databases, and user devices for the transmission and reception of data in real time.

The I/O devices 622 represent an array of peripherals used for user interaction and system control, comprising input devices such as a keyboard, mouse, or touchscreen, as well as output devices such as a monitor or printer. These devices allow users to input data, receive feedback, and control operations within the environment 600, enhancing the user's ability to interact with and manage the computing system.

In various embodiments, the environment 600 may be configured to execute software applications, perform data processing tasks, and support data storage operations, while maintaining real-time communication with networked systems. This configuration enables the environment 600 to support multiple, concurrent operations essential for implementing the functionalities described in the present disclosure, with secure, flexible, and efficient data handling across internal and external channels. The environment 600 may be particularly suited for implementing the dual-environment architecture described in the present disclosure, where sensitive data is processed securely in a secured environment while leveraging the capabilities of Large Language Models (LLMs) in an untrusted environment.

The processor 602 may execute instructions stored in the memory 606 to perform the steps of the method described in FIG. 5, comprising receiving user requests, anonymizing the sensitive data, transmitting anonymized requests to the untrusted environment, de-anonymizing responses, and executing action instructions on sensitive data sources. The communication I/F 618 may facilitate secure communication between the secured environment and the untrusted environment, ensuring that the sensitive data is protected during transmission. The I/O devices 622 may allow users to interact with the system, submit requests, and receive responses, while the storage devices 608 may store the sensitive data and system logs securely within the secured environment.

By implementing the environment 600, organizations may ensure that the sensitive data is processed securely while leveraging the power of Large Language Models (LLMs) for advanced analytics and automation. The environment 600 may provide a scalable, secure approach to data processing, supporting both individual and bulk operations across multiple user requests. This setup may enhance data security, ensure compliance with regulatory requirements, and enable organizations to fully utilize the capabilities of AI-driven tools without compromising sensitive information.

It will be appreciated that, for clarity purposes, the above description has described embodiments of the disclosure with reference to different mechanical components and their functionalities. However, it will be apparent that any suitable distribution of functionality between different components or assemblies may be used without detracting from the disclosure. For example, functionality illustrated to be performed by separate components may be integrated into a single component or assembly. Hence, references to specific components are only to be seen as references to suitable means for providing the described functionality, rather than indicative of a strict structural or organizational configuration.

Although the present disclosure has been described in connection with some embodiments, it is not intended to be limited to the specific form set forth herein. Rather, the scope of the present disclosure is limited only by the claims. Additionally, although a feature may appear to be described in connection with particular embodiments, one skilled in the art would recognize that various features of the described embodiments may be combined in accordance with the disclosure.

Furthermore, although individually listed, a plurality of means, elements or process steps may be implemented by, for example, a single unit or processor. Additionally, although individual features may be comprised in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A computer-implemented method (500) for securely processing sensitive data (318) using a dual-environment architecture, the computer-implemented method (500) comprising:
receiving (502), by a processor (104) and in a secured environment (302), a user request comprising sensitive data (318) in an original form, via a user interface (110);
anonymizing (504), by the processor (104) and in the secured environment (302), the user request by replacing the sensitive data (318) with anonymized tokens, wherein a session-based mapping is maintained between the sensitive data (318) and the anonymized tokens;
transmitting (506), by the processor (104), the anonymized user request from the secured environment (302) to an application within an untrusted environment (304), wherein the application uses one or more Large Language Models (LLMs) (314);
transmitting (508), by the processor (104), a response comprising action instructions (320) from the untrusted environment (304) to the secured environment (302), without a direct access to the sensitive data (318), in response to receiving the anonymized user request, wherein the response is generated using the application;
de-anonymizing (510), by the processor (104) and in the secured environment (302), the response by replacing the anonymized tokens corresponding to the sensitive data (318) with the sensitive data (318) in the original form using the session-based mapping; and
executing (512), by the processor (104), the action instructions (320) on sensitive data sources (322) in the secured environment (302).

2. The computer-implemented method (500) according to claim 1, wherein the one or more LLMs (314) are pre-trained.

3. The computer-implemented method (500) according to claim 1, wherein the anonymizing (504) further comprises:
identifying the sensitive data (318) in the user request using Personally Identifiable Information (PII) classification techniques; and
replacing the sensitive data (318) with anonymized tokens while maintaining the session-based mapping between the sensitive data (318) in the original form and the anonymized tokens.

4. The computer-implemented method (500) according to claim 1, wherein the action instructions (320) comprise any actions in the secured environment (302) comprising at least one of database queries, report generation, log analysis, and/or document retrieval, and wherein the action instructions (320) are validated against a set of pre-defined rules to ensure that actions performed within the secured environment (302) align with security policies.

5. The computer-implemented method (500) according to claim 1, further comprising:
encrypting a connection between the secured environment (302) and the untrusted environment (304) using any secured application layer communication method comprising Secure Sockets Layer (SSL) encryption.

6. The computer-implemented method (500) according to claim 1, further comprising:
authorizing the execution of the action instructions (320) based on user-level permissions before executing the action instructions (320) in the secured environment (302).

7. The computer-implemented method (500) according to claim 1, further comprising:
enriching the one or more LLMs (314), in the untrusted environment (304), with non-sensitive metadata about the secured environment (302), comprising available actions, to generate the action instructions (320) without direct access to the sensitive data (318).

8. The computer-implemented method (500) according to claim 1, further comprising:
storing, in the secured environment (302), a history of anonymized user requests and responses to improve relevance of future responses.

9. The computer-implemented method (500) according to claim 1, wherein the sensitive data (318) comprise an internal database comprising at least one of a vector database, Active Directory, or a logs database.

10. A system (100) for securely processing sensitive data (318) using a dual-environment architecture, the system (100) comprising:
a processor (104); and
a memory (106) communicatively coupled to the processor (104), wherein the memory (106) stores processor-executable instructions, which, on execution, cause the processor (104) to:
receive (502), in a secured environment (302), a user request comprising sensitive data (318) in an original form via a user interface (110);
anonymize (504), in the secured environment (302), the user request by replacing the sensitive data (318) with anonymized tokens, wherein a session-based mapping is maintained between the sensitive data (318) and the anonymized tokens;
transmit (506) the anonymized user request from the secured environment (302) to an application within an untrusted environment (304), wherein the application uses one or more Large Language Models (LLMs) (314);
transmit (508) a response comprising action instructions (320) from the untrusted environment (304) to the secured environment (302), without a direct access to the sensitive data (318), in response to receiving the anonymized user request, wherein the response is generated using the application;
de-anonymize (510) the response by replacing the anonymized tokens corresponding to the sensitive data (318) with the sensitive data (318) in the original form using the session-based mapping; and
execute (512), in the secured environment (302), the action instructions (320) on sensitive data sources (322).

11. The system (100) according to claim 10, wherein:
the one or more LLMs (314) are pre-trained; and
the one or more LLMs (314) are enriched, in the untrusted environment (304), with non-sensitive metadata about the secured environment (302), comprising available actions, to generate the action instructions (320) without direct access to the sensitive data (318).

12. The system (100) according to claim 10, wherein a history of anonymized user requests and responses is stored in the secured environment (302) to improve relevance of future responses, and wherein the processor-executable instructions further cause the processor (104) to:
identify sensitive data (318) in the user request using Personally Identifiable Information (PII) classification techniques; and
replace the sensitive data (318) with anonymized tokens while maintaining the session-based mapping between the sensitive data (318) in the original form and the anonymized tokens.

13. The system (100) according to claim 10, wherein:
the action instructions (320) comprise any actions in the secured environment (302) comprising at least one of database queries, report generation, log analysis, and/or document retrieval; and
the execution of the action instructions (320) is authorized based on user-level permissions before executing the action instructions (320) in the secured environment (302).

14. The system (100) according to claim 10, wherein a connection between the secured environment (302) and the untrusted environment (304) is encrypted using any secured application layer communication method comprising Secure Sockets Layer (SSL) encryption.

15. The system (100) according to claim 10, wherein the sensitive data sources (322) comprise at least one of a vector database, Active Directory, or a logs database.
